(19) United States
(12) Patent Application Publication
(10) Pub. No.: US 2003/0220779 A1
(43) Pub. Date: Nov. 27, 2003

(54) Extracting semiconductor device model parameters

(76) Inventors: Ping Chen, San Jose, CA (US); Jushan Xie, Campbell, CA (US)

Correspondence Address: Pennie & Edmonds, LLP, 3300 Hillview Avenue, Palo Alto, CA, 94304, US

(21) Appl. No.: 10/404,630

(22) Filed: Mar. 31, 2003

Related U.S. Application Data
(60) Provisional application No. 60/368,599, filed on Mar. 29, 2002.

(51) Int. Cl. G06F 17/50; G06F 9/45

(52) U.S. Cl. 703/14; 703/22

(57) ABSTRACT

The present invention includes a method for extracting semiconductor device model parameters for a device model such as the BSIMPD model. The method comprises obtaining terminal current data corresponding to various bias conditions in a set of test devices and extracting a portion of a plurality of DC model parameters for the device model from the terminal current data. The terminal current are then modified based on the extracted portion of the DC model parameters before extracting additional DC model parameters. The present invention also includes novel methods for extracting some of the DC model parameters.

This patent claims priority pursuant to 35 U.S.C. § 119(e)1 to U.S. Provisional Patent Application Serial No. 60/368,599, filed Mar. 29, 2002.

### FIELD OF THE INVENTION

The invention relates generally to computer-aided electronic circuit simulation, and more particularly, to a method of extracting semiconductor device model parameters for use in integrated circuit simulation.

### BACKGROUND OF THE INVENTION

Computer aids for electronic circuit designers are becoming more prevalent and popular in the electronic industry. This move toward electronic circuit simulation was prompted by the increase in both complexity and size of circuits. As circuits have become more complex, traditional breadboard methods have become burdensome and overly complicated. With increased computing power and efficiency, electronic circuit simulation is now standard in the industry. Examples of electronic circuit simulators include the Simulation Program with Integrated Circuit Emphasis (SPICE) developed at the University of California, Berkeley (UC Berkeley), and various enhanced versions or derivatives of SPICE, such as, SPICE2 or SPICE3, also developed at UC Berkeley; HSPICE, developed by Meta-software and now owned by Avant!; PSPICE, developed by Micro-Sim; and SPECTRE, developed by Cadence. SPICE and its derivatives or enhanced versions will be referred to hereafter as SPICE circuit simulators.

SPICE is a program widely used to simulate the performance of analog electronic systems and mixed mode analog and digital systems. SPICE solves sets of non-linear differential equations in the frequency domain, steady state and time domain and can simulate the behavior of transistor and gate designs. In SPICE, any circuit is handled in a node/element fashion; it is a collection of various elements (resistors, capacitors, etc.). These elements are then connected at nodes. Thus, each element must be modeled to create the entire circuit. SPICE has built in models for semiconductor devices, and is set up so that the user need only specify model parameter values.

An electronic circuit may contain any variety of circuit elements such as resistors, capacitors, inductors, mutual inductors, transmission lines, diodes, bipolar junction transistors (BJT), junction field effect transistors (JFET), and metal-oxide-semiconductor field effect transistors (MOSFET), etc. A SPICE circuit simulator makes use of built-in or plug-in models for semiconductor device elements such as diodes, BJTs, JFETs, and MOSFETs. If model parameter data is available, more sophisticated models can be invoked. Otherwise, a simpler model for each of these devices is used by default.

A model for a device mathematically represents the device characteristics under various bias conditions. For example, for a MOSFET device model, in DC and AC analysis, the inputs of the device model are the drain-to-source, gate-to-source, bulk-to-source voltages, and the device temperature. The outputs are the various terminal currents. A device model typically includes model equations and a set of model parameters. The model parameters, along with the model equations in the device model, directly affect the final outcome of the terminal currents. In order to represent actual device performance, a successful device model is tied to the actual fabrication process used to manufacture the device represented. This connection is represented by the model parameters, which are dependent on the fabrication process used to manufacture the device.

SPICE has a variety of preset models. However, in modern device models, such as BSIM (Berkeley Short-Channel IGFET Model) and its derivatives, BSIM3, BSIM4, and BSIMPD (Berkeley Short-Channel IGFET Model Partial Depletion), all developed at UC Berkeley, only a few of the model parameters can be directly measured from actual devices. The rest of the model parameters are extracted using nonlinear equations with complex extraction methods. See Daniel Foty, “MOSFET Modeling with Spice—Principles and Practice,” Prentice Hall PTR, 1997.

Since the sets of equations utilized in a modern semiconductor device model are complex with numerous unknowns, there is a need to extract the model parameters in the equations in an efficient and accurate manner so that using the extracted parameters, the model equations will closely emulate the actual process.

### SUMMARY OF THE INVENTION

The present invention includes a method for extracting semiconductor device model parameters for a device model such as the BSIMPD model. The device model parameters for the device model includes a plurality of base parameters, DC model parameters, temperature dependent related parameters, and AC parameters. The method comprises obtaining terminal current data corresponding to various bias conditions in a set of test devices and extracting a first portion of the DC model parameters for the device model from the terminal current data. The terminal current data are then first modified based on the extracted first portion of the DC model parameters. The method may further comprise extracting a second portion of the DC model parameters and further modifying the first-modified terminal current data based on the extracted second portion of the DC model parameters. The method further comprises extracting additional DC model parameters based on the first-modified or the further-modified terminal current data.

The present invention also includes novel methods for extracting the first portion of the DC model parameters, the second portion of the DC model parameters, and some of the additional DC model parameters, as explained in more detail below.

### BRIEF DESCRIPTION OF THE DRAWINGS

FIG. 1 is a block diagram of a system according to an embodiment of the present invention;

FIG. 2 is a flow chart illustrating a modeling process in accordance with an embodiment of the present invention;

FIG. 3A is a block diagram of a model definition input file in accordance with an embodiment of the present invention;

FIG. 3B is a block diagram of an object definition input file in accordance with an embodiment of the present invention;

FIG. 4 is a diagrammatic cross sectional view of a silicon-on-insulator MOSFET device for which model parameters are extracted in accordance with an embodiment of the present invention;

FIG. 5 is a graph illustrating sizes of test devices used to obtain experimental data for model parameter extraction in accordance with an embodiment of the present invention;

FIG. 6 is a graph illustrating sizes of test devices used to obtain experimental data for model parameter extraction in accordance with an alternative embodiment of the present invention;;

FIGS. 7A-7D are examples of current-voltage (I-V) curves representing some of the terminal current data for the test devices;

FIG. 8 is a flow chart illustrating in further detail a parameter extraction process in accordance with an embodiment of the present invention;

FIG. 9 is a flow chart illustrating in further detail a DC parameter extraction process in accordance with an embodiment of the present invention;

FIG. 10 is a flow chart illustrating a process for extracting diode current related parameters in accordance with an embodiment of the present invention; and

FIG. 11 is a flow chart illustrating a process for extracting impact ionization current related parameters in accordance with an embodiment of the present invention.

### DETAILED DESCRIPTION OF THE INVENTION

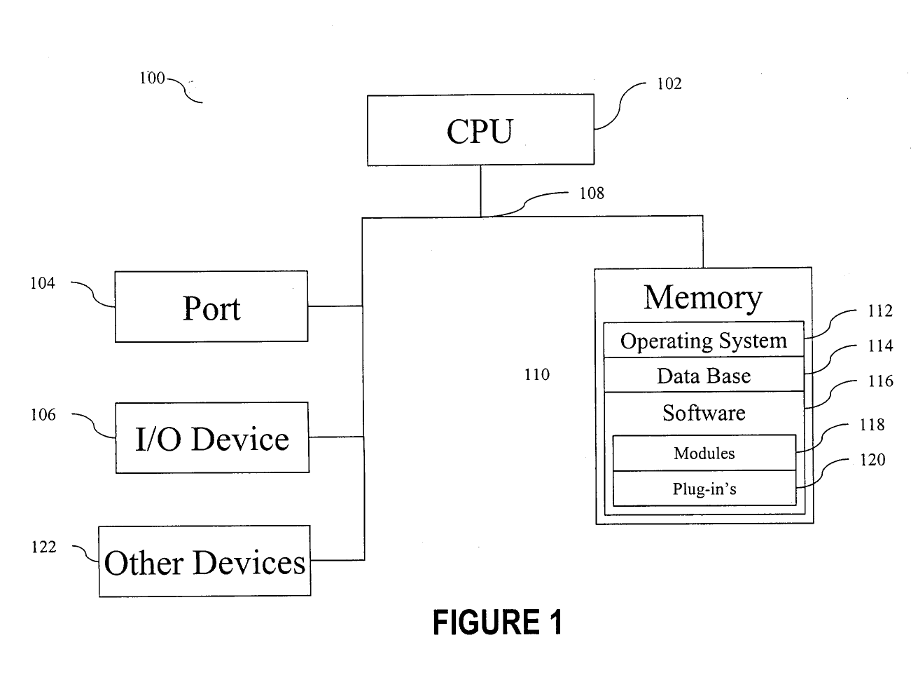

As shown in FIG. 1, system 100, according to one embodiment of the invention, comprises a central processing unit (CPU) 102, which includes a RAM, and a disk memory 110 coupled to the CPU 102 through a bus 108. The system 100 further comprises a set of input/output (I/O) devices 106, such as a keypad, a mouse, and a display device, also coupled to the CPU 102 through the bus 108. The system 100 may further include an input port 104 for receiving data from a measurement device (not shown), as explained in more detail below. The system 100 may also include other devices 122. An example of system 100 is a Pentium 233 PC/Compatible computer having RAM larger than 64 MB and a hard disk larger than 1 GB.

Memory 110 has computer readable memory spaces such as database 114 that stores data, memory space 112 that stores operating system 112 such as Windows 95/98/NT4.0/2000, which has instructions for communicating, processing, accessing, storing and searching data, and memory space 116 that stores program instructions (software) for carrying out the method of the present invention. Memory space 116 may be further subdivided as appropriate, for example to include memory portions 118 and 120 for storing modules and plug-in models, respectively, of the software.

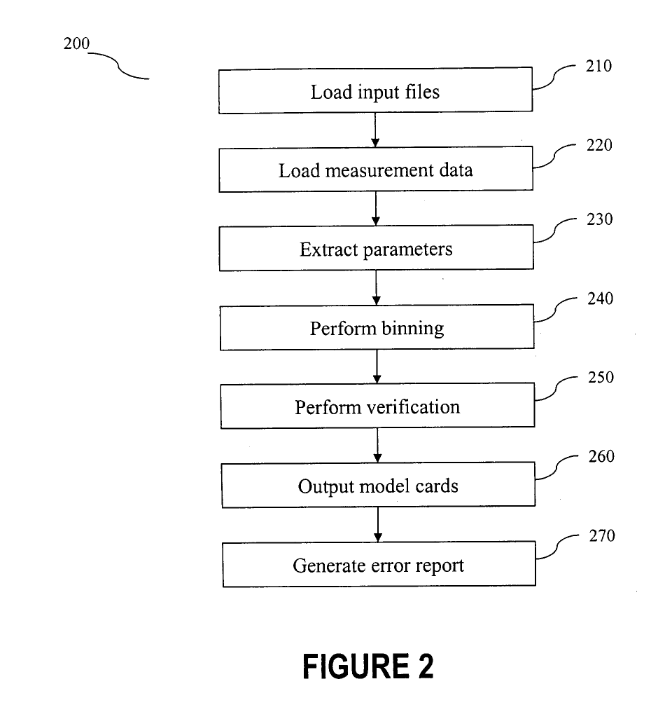

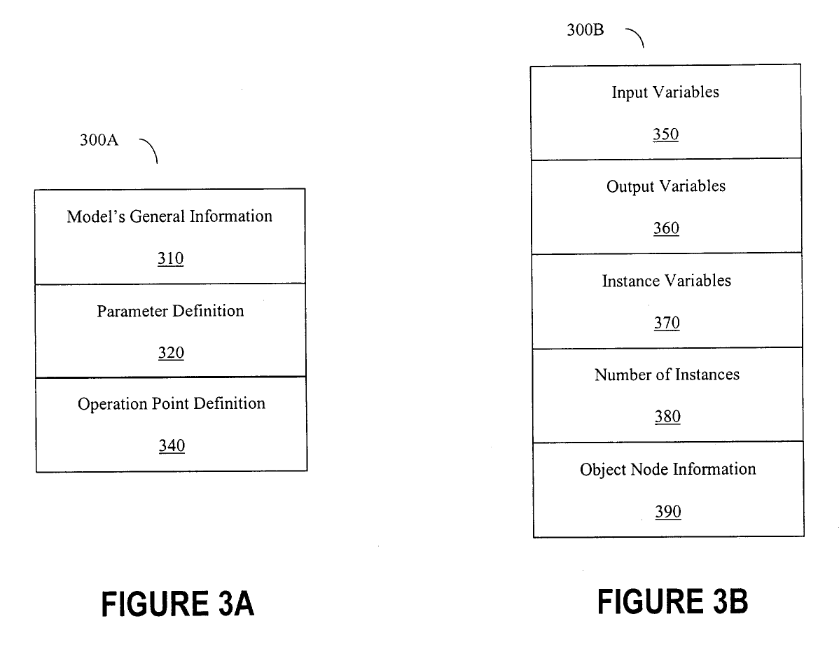

A set of model parameters for a semiconductor device is often referred to as a model card for the device. Together with the model equations, the model card is used by a circuit simulator to emulate the behavior of the semiconductor device in an integrated circuit. A model card may be determined by process 200 as shown in FIG. 2. Process 200 includes step 210 in which one or more input files are loaded into the RAM of the CPU 102. The input files may include a model definition file and an object definition file. The object definition file provides information of the object (device) to be simulated. The model definition file provides information associated with the device model for modeling the behavior of the object. These files are discussed in further detail below in connection with FIGS. 3A and 3B.

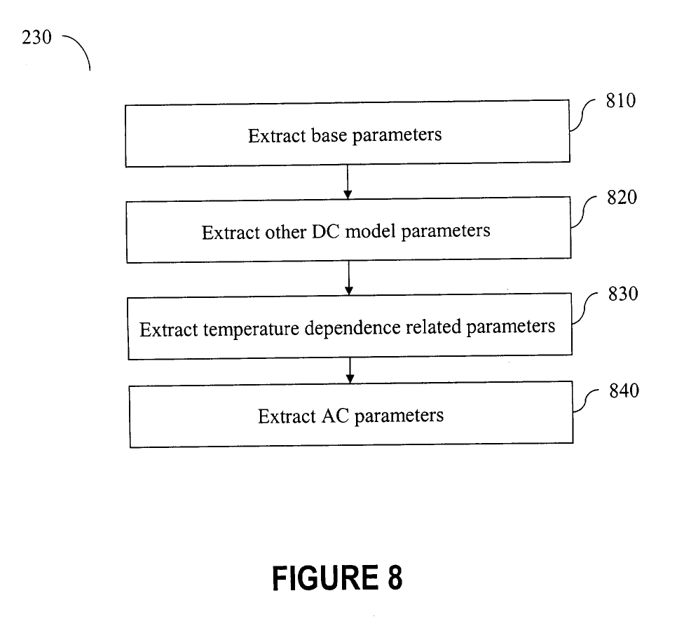

Process 200 further includes step 220 in which the measurement data is loaded from database 114. The measurement data includes physical measurements from a set of test devices, as will be explained in more detail below. Once the measurement data has been loaded, process 200 proceeds to extract in step 230 the model parameters. The parameter extraction step 230 is discussed in detail in connection with FIGS. 8, 9, 10 and 11 below.

After the parameters are extracted, binning may be performed in step 240. The binning step 240 is an optional step and it may depend on whether the device model is binnable or not. Process 200 further includes step 250, in which the extracted model parameters are verified. Once verified, the extracted parameters are output in step 260 as a model card. An error report may be generated afterwards in step 270, and the process 200 is then complete. More detailed discussion about the binning step 240 and verification step 250 can be found in the BSIMPro+ User Mannual—Basic Operation, by Celestry Design Technologies, released in September, 2001, which is incorporated by reference in its entirety herein.

Referring to FIG. 3A, the model definition file 300A comprises a general model information field 310, a parameter definition field 320, an intermediate variable definition field 330, and an operation point definition field 340. The general model information field 310 includes general information about the device model, such as a model name, a model version, a model type, compatible circuit simulators, and binning information. The parameter definition field 320 defines the parameters in the model. As an example, a list of the model parameters in the BSIMPD model are provided in Appendix A. For each parameter, the model definition file also specifies information associated with the parameter, such as a parameter name, a default value, a parameter unit, a data type, and optimization information. The operation point definition section 340 defines operation point or output variables, such as device terminal currents, threshold voltage, etc., used by the model.

Referring to FIG. 3B, object definition file 300B defines object related information, including input variables 350, output variables 360, instance variables 370, and object and node information 380. Input variables 350 and output variables 360 are associated with the inputs and outputs, respectively, of the device in an integrated circuit. The instance variables 370 are associated with the geometric characteristics of the device to be modeled. The object node information 380 includes information regarding the nodes or terminals of the device to be modeled.

Process 200 can be used to generate model cards for models describing semiconductor devices such as BJTs, JFETs, and MOSFETs, etc. Discussions about the use of some of these models can be found in the BSIMPro+ User Mannual—Device Modeling Guide, by Celestry Design Technologies, released in September, 2001, which is incorporated by reference in its entirety herein. As an example, the BSIMPD model, which was developed by UC Berkley to model silicon-on-insulator (SOI) MOSFET devices, is used here to illustrate the parameter extraction step 230 of the process 200. The model equations for the BSIMPD model are provided in Appendix B. More detailed discussion about the BSIMPD model can be found in the BSIMPD2.2 MOSFET Model Users' Manual by the Department of Electrical Engineering and Computer Sciences, UC Berkeley, Copyright 1999, which is incorporated herein by reference in its entirety.

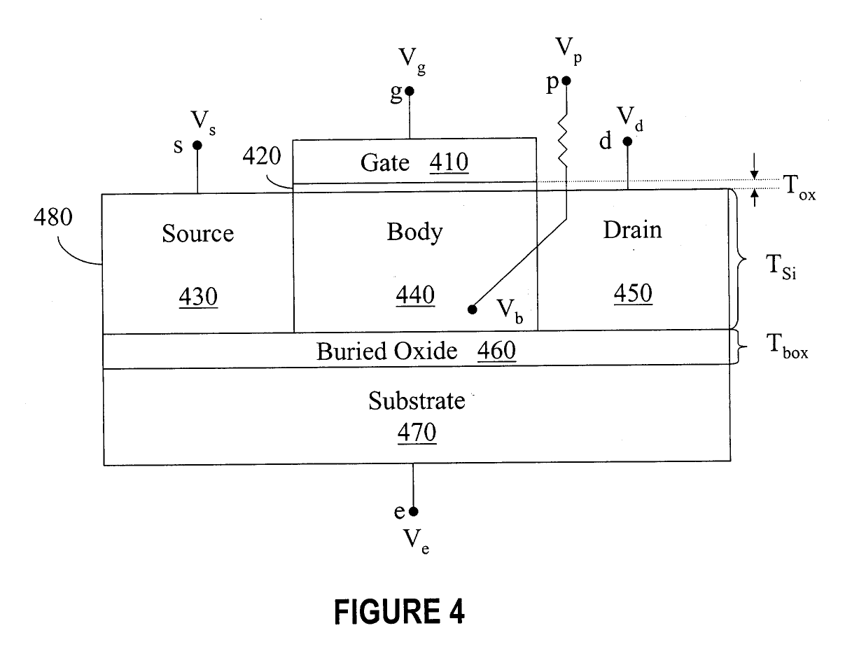

As shown in FIG. 4, an SOI MOSFET device 400 may comprise a thin silicon on oxide (SOI) film 480, having a thickness Tₛᵢ, on top of a layer of buried oxide 460, having a thickness T_{box}. The SOI film 480 has two doped regions, a source 430 and a drain 450, separated by a body region 440. The SOI MOSFET also comprises a gate 410 on top of the body region 440 and is separated from SOI film 480 by a thin layer of gate oxide 420. The SOI MOSFET 400 is formed on a semiconductor substrate 470.

The SOI MOSFET as described can be considered a five terminal (node) device. The five terminals are the gate terminal (node g), the source terminal (node s), the drain terminal (node d), the body terminal (node p), and the substrate terminal (node e). Nodes g, s, d, and e can be connected to different voltage sources while node p can be connected to a voltage source or left floating. In the floating body configuration there are four external biases , the gate voltage (V_{g}), the drain voltage (V_{d}), the source voltage (Vₛ) and the substrate bias Vₑ. If body contact is applied, there will be an additional external bias, the body contact voltage (Vₚ).

For ease of further discussion, Table I below lists the symbols corresponding to the physical variables associated with the operation of SOI MOSFET device 400.

TABLE I

| | |
|---|---|
| C_{pd} | body to drain capacitance |
| Cₚₛ | body to source capacitance |
| I_{c} | parasitic bipolar transistor collector current |
| Iₚ | current through body (p) node |
| I_{bjt} | parasitic bipolar junction transistor current |
| I_{d} | current through drain (d) node |
| I_{dgidl} | gate induced leakage current at the drain |
| I_{diode} | diode current |
| I_{ds} | current flowing from source to drain |
| I_{dsat} | drain saturation current |
| Iₑ | current through substrate (e) node |
| I_{g} (or J_{gb}) | gate oxide tunneling current |
| I_{gs} | current flowing from source to gate |
| Iᵢᵢ | impact ionization current |
| Iₛ | current through source (s) node |
| I_{sgidl} | gate induced drain leakage current at the source |
| L_{drawn} | drawn channel length |
| L_{eff} | effective channel length |
| R_{d} | drain resistance |
| Rₛ | source resistance |
| R_{ds} | drain/source resistance |
| Rₒᵤₜ | output resistance |
| V_{b} | internal body voltage |
| V_{bs} | voltage between node p and node s |
| V_{d} | drain voltage |
| V_{DD} | maximum operating DC voltage |
| V_{ds} | voltage between node d and node s |
| Vₑ | substrate voltage |
| V_{g} | gate voltage |
| V_{gs} | voltage between node g and node s |
| Vₚ | body contact voltage |
| Vₛ | source voltage |
| Vₜₕ | threshold voltage |
| W_{drawn} | drawn channel width |
| W_{eff} | effective channel width |

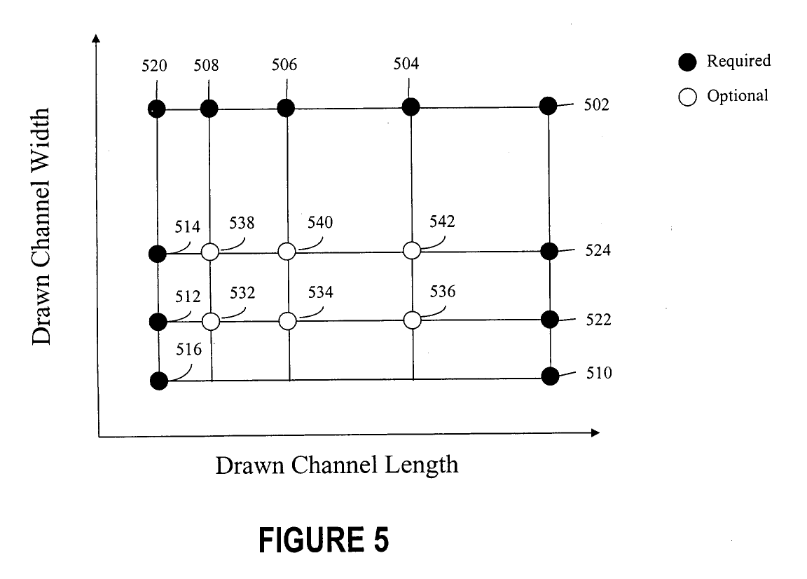

In order to model the behavior of the SOI MOSFET device 400 using the BSIMPD model, experimental data are used to extract model parameters associated with the model. These experimental data include terminal current data and capacitance data measured in test devices under various bias conditions. In one embodiment of the present invention, the measurement is done using a conventional semiconductor device measurement tool that is coupled to system 100 through input port 104. The measured data are thus organized by CPU 102 and stored in database 114. The test devices are typically manufactured using the same or similar process technologies for fabricating the SOI MOSFET device. In one embodiment of the present invention, a set of test devices having different device sizes, meaning different channel widths and channel lengths are used for the measurement. The device size requirement can vary with different applications. Ideally, as shown in FIG. 5, the set of devices include:

a. one largest device, meaning the device with the longest drawn channel length and widest drawn channel width that is available, as represented by dot 502;

b. one smallest device, meaning the device with the shortest drawn channel length and smallest drawn channel width that is available, as represented by dot 516;

c. one device with the smallest drawn channel width and longest drawn channel length, as represented by dot 510;

d. one device with the widest drawn channel width and shortest drawn channel length, as represented by dot 520;

e. three devices having the widest drawn channel width and different drawn channel lengths, as represented by dots 504, 506, and 508;

f. two devices with the shortest drawn channel length and different drawn channel widths, as represented by dots 512 and 514;

g. two devices with the longest drawn channel length and different drawn channel widths, as represented by dots 522 and 524;

h. (optionally) up to three devices with smallest drawn channel width and different drawn channel lengths, as represented by dots 532, 534, and 536; and

i. (optionally) up to three devices with medium drawn channel width (about halfway between the widest and smallest drawn channel width) and different drawn channel lengths, as represented by dots 538, 540, and 542.

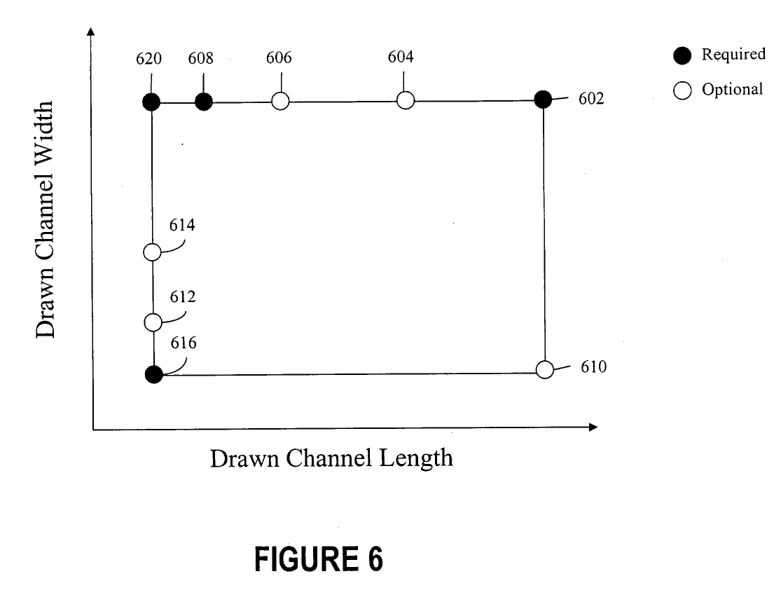

If in practice, it is difficult to obtain measurements for all of the above devices sizes, a smaller set of different sized devices can be used. For example, the different device sizes shown in FIG. 6 are sufficient in one embodiment of the present invention. The test devices as shown in FIG. 6 include:

a. one largest device, meaning the device with the longest drawn channel length and widest drawn channel width, as represented by dot 602;

b. one smallest device, meaning the device with the shortest drawn channel length and smallest drawn channel width, as represented by dot 616;

c. (optional) one device with the smallest drawn channel width and longest drawn channel length, as represented by dot 610;

d. one device with the widest drawn channel width and shortest drawn channel length, as represented by dot 620;

e. one device and two optional devices having the widest drawn channel width and different drawn channel lengths, as represented by dots 604, 606, and 608, respectively;

f. (optional) two devices with the shortest drawn channel length and different drawn channel widths, as represented by dots 612 and 614.

For each test device, terminal currents are measured under different terminal bias conditions: These terminal current data are put together as I-V curves representing the I-V characteristics of the test device. In one embodiment of the present invention, for each test device, the following I-V curves are obtained:

1. Linear region I_{d} vs. V_{gs} curves for a set of Vₚ values. These curves are obtained by grounding the s node and the e node, setting V_{d} to a low value, such as 0.05V, and for each of the set of Vₚ values, measuring I_{d} while sweeping V_{g} in step values across a range such as from 0 to V_{DD}.

2. Saturation region I_{d} vs. V_{gs} curves for a set of Vₚ values. These curves are obtained by grounding the s node and the e node, setting V_{d} to a high value, such as V_{DD}, and for each of the set of Vₚ values, measuring I_{d} while sweeping V_{g} in step values across a range such as from 0 to V_{DD}.

3. I_{d} vs. V_{gs} curves for different V_{d}, Vₚ and Vₑ values, obtained by grounding the s node, and for each combination of V_{d}, Vₚ and Vₑ values, measuring I_{d} while sweeping V_{g} in step values across a range such as from −V_{DD} to V_{DD}.

4. I_{g} vs. V_{gs} curves for different V_{d}, Vₚ and Vₑ values, obtained by grounding the s node, and for each combination of V_{d} Vₚ and Vₑ values, measuring I_{g} while sweeping V_{g} in step values across a range such as from −V_{DD} to V_{DD}.

5. Iₛ vs. V_{ds} curves for different V_{g}, Vₚ and Vₑ values, obtained by grounding the s node, and for each combination of V_{g}, Vₚ and Vₑ values, measuring Iₛ while sweeping V_{d} in step values across a range such as from 0 to V_{DD}.

6. Iₚ vs. V_{gs} curves for different V_{d}, Vₚ and Vₑ values, obtained by grounding the s node, and for each combination of V_{d}, Vₚ and Vₑ values, measuring Iₚ while sweeping V_{g} in step values across a range such as from −V_{DD} to V_{DD}.

7. I_{d} vs. V_{gs} curves for different V_{d}, Vₚ and Vₑ values, obtained by grounding the s node, and for each combination of Vₚ, V_{d} and Vₑ values, measuring I_{d} while sweeping V_{g} in step values across a range such as from −V_{DD} to V_{DD}.

8. I_{d} vs. Vₚₛ curves for different V_{d}, V_{g} and Vₑ values, obtained by grounding the s node, and for each combination of V_{g}, V_{d} and Vₑ values, measuring I_{d} while sweeping Vₚ in step values across a range such as from −V_{DD} to V_{DD}.

9. Floating body I_{d} vs. V_{gs} curves for different V_{d} and Vₑ values, obtained by grounding the s node, floating the b node, and for each combination of V_{d} and Vₑ values, measuring I_{d} while sweeping V_{g} in step values across a range such as from 0 to V_{DD}.

10. Floating body I_{d} vs. V_{ds} curves for different V_{g} and Vₑ values, obtained by grounding the s node, floating the b node, and for each combination of V_{g} and Vₑ values, measuring I_{d} while sweeping V_{d} in step values across a range such as from 0 to V_{DD}.

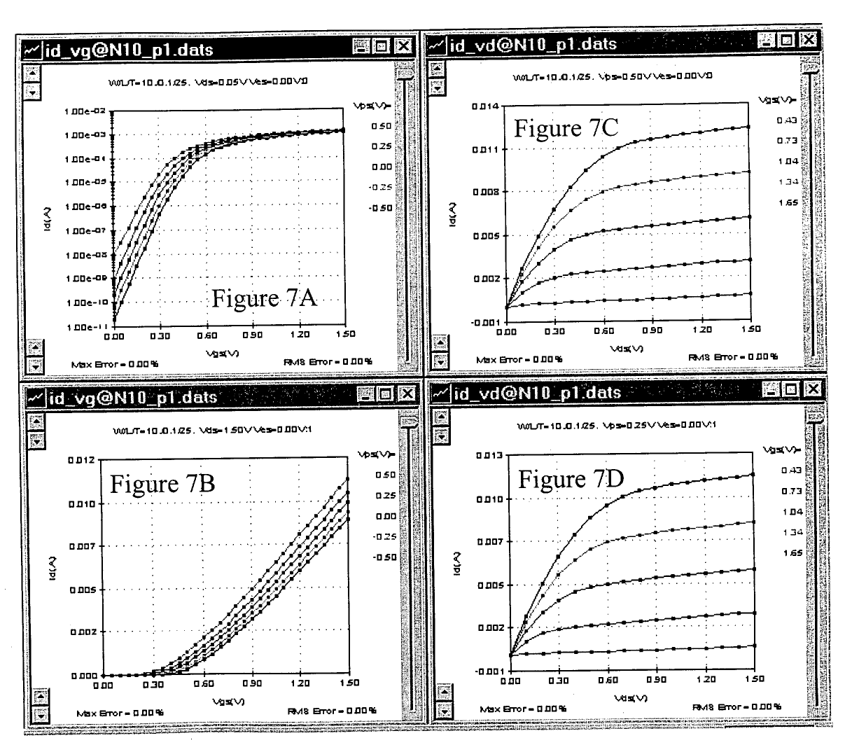

As examples, FIG. 7A shows a set of linear region I_{d} vs. V_{gs} curves for different Vₚₛ values, FIG. 7B shows a set of saturation region I_{d} vs. V_{gs} curves for different Vₚₛ values, FIG. 7C shows a set of I_{d} vs. V_{ds} curves for different V_{gs} values while Vₚₛ=0.5V and Vₑₛ=0; FIG. 7D shows a set of I_{d} vs. V_{ds} curves for different V_{gs} values while Vₚₛ=0.25V and Vₑₛ=0.

In addition to the terminal current data, for each test device, capacitance data are also collected from the test devices under various bias conditions. The capacitance data can be put together into capacitance-current (C-V) curves. In one embodiment of the present invention, the following C-V curves are obtained:

a. Cₚₛ vs. Vₚₛ curve obtained by grounding s node, setting Iₑ and I_{d} to zero, or to very small values, and measuring Cₚₛ while sweeping Vₚ in step values across a range such as from −V_{DD} to V_{DD}.

b. C_{pd} vs. Vₚₛ curve obtained by grounding s node, setting Iₑ and Iₛ to zero, or to very small values, and measuring C_{pd} while sweeping Vₚ in step values across a range such as from −V_{DD} to V_{DD}.

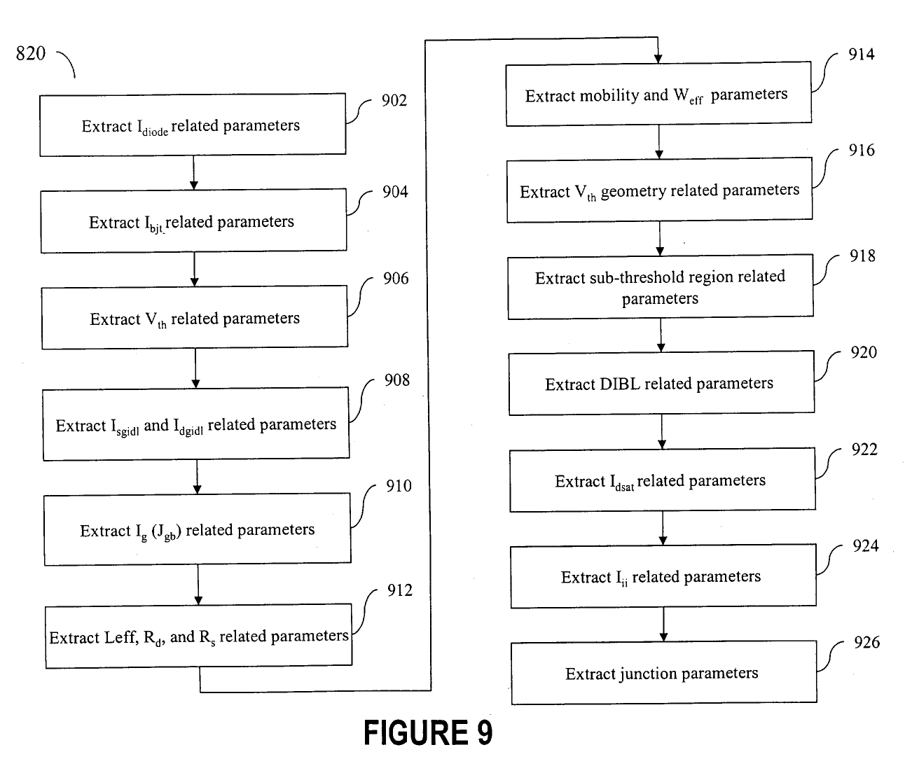

As shown in FIG. 8, in one embodiment of the present invention, the parameter extraction step 230 comprises step 810 for extracting base parameters, step 820 for extracting other DC model parameters, step 830 for extracting temperature dependent related parameters; and step 840 for extracting AC parameters. In step 810, base parameters, such as Vₜₕ (the threshold voltage when V_{bs}=0), K₁ (the first order body effect coefficient), and K₂ ( the second order body effect coefficient) are extracted based on process parameters corresponding to the process technology used to fabricate the SOI MOSFET device to be modeled. The base parameters are then used to extract other DC model parameters at step 820, which is explained in more detail in connection with FIGS. 9, 10, and 11 below.

The temperature dependent parameters are parameters that may vary with the temperature of the device and include parameters such as: Ktl1(temperature coefficient for threshold voltage); Ua1 (temperature coefficient for Uₐ), and Ub1 (temperature coefficient for U_{b}), etc. These parameters can be extracted using a conventional parameter extraction method.

The AC parameters are parameters associated with the AC characteristics of the SOI MOSFET device and include parameters such as: CLC (the constant term for the short chanel model) and moin (the coefficient for the gate-bias dependent surface potential), etc. These parameters can also be extracted using a conventional parameter extraction method.

As shown in FIG. 9, the DC parameter extraction step 820 further comprises: extracting I_{diode} related parameters (step 902); extracting I_{bjt} related parameters (step 904); extracting Vₜₕ related parameters (step 906); extracting I_{dgid1} and I_{sgid1} related parameters (step 908); extracting I_{g} (or J_{gb}) related parameters (step 910); extracting L_{eff} related parameters, R_{d} related parameters and Rₛ related parameters (step 912); extracting mobility related parameters and W_{eff} related parameters (step 914); extracting Vₜₕ geometry related parameters (step 916); extracting sub-threshold region related parameters (step 918); extracting parameters related to drain-induced barrier lower than regular (DIBL) (step 920); extracting I_{dsat} related parameters (step 922); extracting Iᵢᵢ related parameters (step 924); and extracting junction parameters (step 926).

The equation numbers below refer to the equations set forth in Appendix B.

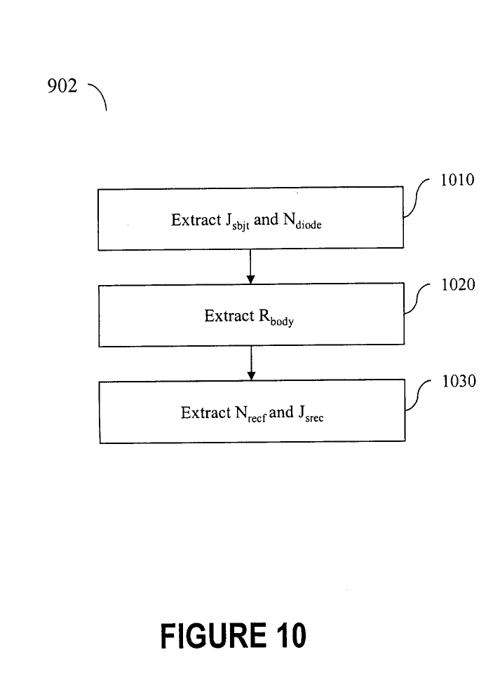

In step 902, parameters related to the calculation of the diode current I_{diode} are extracted. These parameters include, J_{sbjt}, n_{dio}, R_{body}, n_{recf} and j_{srec}. As shown in more detail in FIG. 10, step 902 comprises: extracting J_{sbjt} and n_{dio} (step 1010); extracting R_{body} (step 1020); and extracting n_{recf} and j_{srec} (step 1030).

Model parameters J_{sbjt} and n_{dio} are extracted in step 1010 from the recombination current in neutral body equations (Equations 14.5a -14.5.f) using measured data in the middle part of the I_{d} vs Vₚₛ curves taken from the largest test device (test device having longest L_{drawn} and widest W_{drawn}). By using the largest device, α_{bjt}→0. Then, assuming Aₕₗᵢ=0, E_{hlid} will also equal zero. Therefore Equations 14.5.d -14.5.f can be eliminated. The set of equations is thus reduced to two equations (14.5.b and 14.5.c) with two unknowns, resulting in a quick solution for J_{sbjt} and n_{dio}. In one embodiment of the present invention, the middle part of an I_{d} vs Vₚₛ curve corresponds to the part of the I_{d} vs Vₚₛ curve with Vₚₛ ranging from about 0.3V to about 0.8V. In another embodiment, the middle part of the I_{d} vs Vₚₛ curve corresponds to Vₚₛ ranging from about 0.4V to about 0.7V.

R_{body} is extracted in step 1020 from the body contact current equation (Equations 13.1-13.3) using measured data in the high current part of the I_{d} vs Vₚₛ curves. In one embodiment of the present invention, the high current part of an I_{d} vs Vₚₛ curve corresponds to the part of the I_{d} vs Vₚₛ curve with Vₚₛ ranging from about 0.8V to about 1V.

The parameters n_{recf} and j_{srec} are extracted in step 1030 from the recombination/trap-assisted tunneling current in the depletion region equations (Equations 14.3.a and 14.3.b), also using the I_{d} vs Iₚₛ curves taken from a shortest device. The remaining I_{diode} related parameters are second order parameters and may be neglected.

Referring back to FIG. 9, the parasitic lateral bipolar junction transistor current (I_{bjt}) related parameter Lₙ is extracted in step 904. In this step, a set of I_{c}/Iₚ v. Vₚₛ curves are constructed from the I_{d} vs. Vₚₛ curves taken from a shortest device. Then the bipolar transport factor equations (Equation 14.1) wherein I_{c}/I_{b}=α_{bjt}/1−α_{bjt} are used to extract Lₙ.

In step 906, threshold voltage Vₜₕ related parameters, such as Vₜₕ₀, k1, k2, and Nch, are extracted by using the linear I_{d} vs V_{gs} curves measured from the largest device.

In step 908, parameters related to the gate-induced drain leakage current at the drain and at the source (I_{dgid1}) and the gate-induced drain leakage current at the source (I_{sgid1,}) are extracted. The I_{dgid1} and I_{sgid1} related parameters include parameters such as α_{gid1} and β_{gid1}, and are extracted using the I_{d} vs. V_{gs} curves and Equations 12.1 and 12.2.

In step 910 the oxide tunneling current (I_{g}, also designated as J_{gb}) related parameters are extracted. The I_{g} related parameters include parameters such as V_{EvB}, α_{gb1}, β_{gb1}, V_{gb1}, V_{ECB}, α_{gb2}, β_{gb2}, and V_{gb2}, and are extracted using the I_{g} vs. V_{gs} curves and equations 17.1a-f and 17.2 a-f.

In step 912, parameters related to the effective channel length L_{eff}, the drain resistance R_{d} and source resistance Rₛ are extracted. The L_{eff}, R_{d} and Rₛ related parameters include parameters such as Lᵢₙₜ, and R_{dsw}, and are extracted using data from the linear I_{d} vs V_{gs} curves as well as the extracted Vₜₕ related parameters from step 906.

In step 914, parameters related to the mobility and effective channel width W_{eff}, such as μ₀, Uₐ, U_{b}, U_{c}, Wint, Wri, Prwb, Wr, Prwg, R_{dsw}, Dwg, and Dwb, are extracted, using the linear I_{d} vs V_{gs} curves, the extracted Vₜₕ related parameters, L_{eff} related parameters, R_{d} related parameters, and Rₛ related parameters from steps 906 and 912.

Steps 906, 912, and 914 can be performed using a conventional BSIMPD model parameter extraction method. Discussion of extracting parameters involved in these steps can be found in the following articles: Terada K., Muta H., “A new method to determine effective MOSFET channel length”, Japan J Appl. Phys. 1979:18:953-9; Chern J., Chang P., Motta R., Godinho N., “A new Method to determine MOSFET channel length” IEEE Trans Electron Dev 1980:ED-27:1846-8; and Hassan Md Rofigul, Liou J J, et al. “Drain and source resistances of short-channel LDD MOSFETs,” Solid-State Electron 1997:41:778-80; which are incorporated by reference herein.

In step 916, the threshold voltage Vₜₕ geometry related parameters, such as D_{VT0}, D_{VT1}, D_{VT2}, N_{LX1}, D_{VT0W}, D_{VT1W}, D_{VT2W}, k₃, and k_{3b}, are extracted, using the linear I_{d} vs V_{g} curve, the extracted Vₜₕ related parameters, L_{eff} related parameters, mobility related parameters, and W_{eff} related parameters from steps 906, 912, and 914, and Equations 3.1 to 3.10.

In step 918, sub-threshold region related parameters, such as Cᵢₜ, Nfactor, V_{off}, D_{dsc}, and C_{dscd}, are extracted, using the linear I_{d} vs V_{gs} curves, the extracted Vₜₕ related parameters, L_{eff} related parameters, R_{d} related parameters, Rₛ related parameters, mobility related parameters, and W_{eff} related parameters from steps 906, 912, and 914, and Equations 5.1 and 5.2.

In step 920, DIBL related parameters, such as D_{sub}, Eta0, and Etab, are extracted, using the saturation I_{d} vs V_{gs} curves and the extracted Vₜₕ related parameters from step 906, and Equations 3.1 to 3.10.

In step 922, the drain saturation current I_{dsat} related parameters, such as B0, B1, A0, Keta, and A_{gs}, are extracted using the saturation I_{d} vs V_{d} curves, the extracted Vₜₕ related parameters, L_{eff} related parameters, R_{d} related parameters, Rₛ related parameters, mobility related parameters, W_{eff} related parameters, Vₜₕ geometry related parameters, sub-threshold region related parameters, and DIBL related parameters from steps 906, 912, 914, 916, and 918, and Equations 9.1 to 9.10.

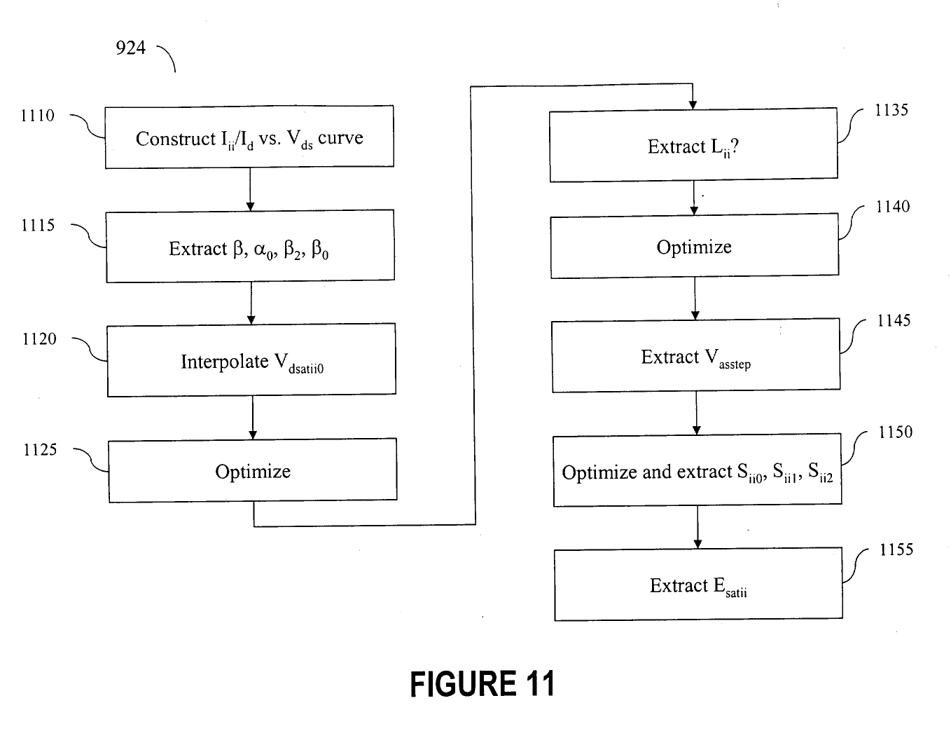

In step 924, the impact ionization current Iᵢᵢ related parameters, such as α₀, β₀, β₁, β₂, V_{dsatii}, and Lᵢᵢ, are extracted, as discussed in detail in connection to FIG. 11 below.

FIG. 11 is a flow chart illustrating in further detail the extraction of the impact ionization current Iᵢᵢ related parameters (step 924). In one embodiment of the present invention, data from the Iₚ v V_{gs} and I_{d} v V_{gs} curves measured from one or more shortest devices are used to construct the Iᵢᵢ/I_{d} vs V_{ds} curves for the one or more shortest devices (step 1110). This begins by identifying the point where V_{gs} is equal to Vₜₕ for each Iₚ v V_{gs} curve, which point is found by setting V_{gst}=0. When V_{gst}=0, V_{gsstep}=0. Then, using the impact ionization current equation, Equation 11.1, the Iᵢᵢ/I_{d} vs V_{ds} curve can be obtained.

After the Iᵢᵢ/I_{d} vs V_{ds} curve is obtained, Lᵢᵢ is set to zero and V_{dsatti0} is set to 0.8 (the default value). Using the Iᵢᵢ/I_{d} vs V_{ds} curve, β₁, α₀, β₂, β₀ are extracted in step 1115 from the impact ionization current equation for Iᵢᵢ, Equation 11.1.

In step 1120, V_{dsatii} is interpolated from a constructed Iᵢᵢ/I_{d} vs V_{ds} curve by identifying the point at which Iₚ/I_{d}=α₀.

Following the interpolation, using a conventional optimizer such as the one using the well known Newton-Raphson algorithm, β₁, β₂, β₀ are optimized in step 1125.

Step 1120 is repeated for each constructed Iᵢᵢ/I_{d} vs V_{ds} curve. This results in an array of values for V_{dsatii}. Using these values for V_{dsatii}, Lᵢᵢ is extracted in step 1135 from the V_{dsatii} equation for the impact ionization current (Equation 11.3).

The extracted β₁, α₀, β₂, β₀, Lᵢᵢ, and V_{dsatti0} are optimized in step 1140 by comparing calculated and measured Iᵢᵢ/I_{d} vs V_{ds} curves for the one or more shorted devices.

In step 1145, the extracted parameters from the Iᵢᵢ and V_{dsatii} equations are used to calculate V_{gsstep} using Equation 11.4 for the largest device. Then in step 1150, Sᵢᵢ₁, Sᵢᵢ₂, Sᵢᵢ₀ are determined using a local optimizer such as the Newton-Raphson algorithm and the V_{gsstep} equation (Equation 11.4).

In the next step 1155, the last of the Iᵢᵢ related parameters is extracted using the shortest device. In this step, Eₛₐₜᵢᵢ is solved for by using the V_{gsstep} equation, Equation 11.4, and the Iᵢᵢ/I_{d} vs V_{ds} curve. The extraction of the Iᵢᵢ, related parameters is then complete.

Referring back to FIG. 9, in step 926, the junction parameters, such as Cjswg, Pbswg, and Mjswg, are extracted using the Cₚₛ vs. Vₚₛ and C_{pd} vs. Vₚₛ curves, and Equations 21.4.b.1 and 21.4.b.2.

In performing the DC parameter extraction steps (steps 901-926), it is preferred that after the I_{diode} and I_{bjt} related parameters are extracted in steps 902 and 904, I_{diode} and I_{bjt} are calculated based on these parameters and the model equations. This calculation is done for the bias condition of each data point in the measured I-V curves. The I-V curves are then modified for a first time based on the calculated I_{diode} and I_{bjt} values. In one embodiment of the present invention, the I-V curves are first modified by subtracting the calculated I_{diode} and I_{bjt} values from respective Iₛ, I_{d}, and Iₚ data values. For example, for a test device having drawn channel length L_{T} and drawn channel width W_{T}, if under the bias condition where Vₛ=Vₛ^{T}, V_{d}=V_{d}^{T}, Vₚ=Vₚ^{T}, Vₑ=Vₑ^{T}, and V_{g}=V_{g}^{T}, the measured drain current is I_{d}^{T}, then after the first modification, the drain current will be I_{d}^{first-modified}=I_{d}^{T}−I_{diode}^{T}−I_{bjt}^{T}, where I_{diode}^{T} and I_{bjt}^{T} are calculated I_{diode} and I_{bjt} values, respectively, for the same test device under the same bias condition. The first-modified I-V curves are then used for additional DC parameter extraction. This results in higher degree of accuracy in the extracted parameters. In one embodiment, the I_{diode} and I_{bjt} related parameters are extracted before extracting other DC parameters, so that I-V curve modification may be done for more accurate extraction of the other DC parameters. However, if such accuracy is not required, one can choose not to do the above modification and the I_{diode} and I_{bjt} related parameters can be extracted at any point in the DC parameter extraction step 820.

Similalry, after the I_{dgid1}, I_{sgidi1} and I_{g} related parameters are extracted in steps 908 and 910, I_{dgid1}, I_{sgid1} and I_{g} are calculated based on these parameters and the model equations. This calculation is done for the bias condition of each data point in the measured I-V curves. The I-V curves or the first-modified I-V curves are then modified or further modified based on the calculated I_{dgid1}, I_{sgid1} and I_{g} values. In one embodiment of the present invention, the I-V curves or first-modified I-V curves are modified or further modified by subtracting the calculated I_{dgid1}, I_{sgid1} and I_{g} values from respective measured or first-modified Iₛ, I_{d}, and Iₚ data values. For example, for a test device having drawn channel length L_{T} and drawn channel width W_{T}, if under bias condition where Vₛ=Vₛ^{T}, V_{d}=V_{d}^{T}, Vₚ=Vₚ^{T}, Vₑ=Vₑ^{T}, and V_{g}=V_{g}^{T}, the measured drain current is I_{d}^{T}, then after the above modification or further modification, the drain current will be I_{d}^{modified}=I_{d}^{T}−I_{dgid1}−I_{sgid1}−I_{g}, or I_{d}^{further-modified}=I_{d}^{first-modified}−I_{dgid1}−I_{sgid1}−I_{g}, where I_{dgid1}, I_{sgid1} and I_{g} are calculated I_{dgid1}, I_{sgid1} and I_{g} values, respectively, for the same test device under the same bias condition. The modified or further modified I-V curves are then used for additional DC parameter extraction. This results in higher degree of accuracy in the parameters extracted afterwards. In one embodiment the I_{dgid1}, I_{sgid1} and I_{g} related parameters are extracted before extracting other DC parameters that can be affected by the modifications, so that I-V curve modification may be done for more accurate extraction of these other DC parameters. However, if such accuracy is not required, one can choose not to do the above modification and the I_{dgid1}, I_{sgid1} and I_{g} related parameters can be extracted at any point in the DC parameter extraction step 820.

The forgoing descriptions of specific embodiments of the present invention are presented for purpose of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. Furthermore, the order of the steps in the method are not necessarily intended to occur in the sequence laid out. It is intended that the scope of the invention be defined by the following claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed:

1. A method for extracting semiconductor device model parameters, comprising:
obtaining terminal current data corresponding to various bias conditions in a set of test devices;
extracting first and second current related parameters from the terminal current data;
modifying the terminal current data using said extracted first current related parameters and second current related parameters; and
extracting additional DC parameters from the modified terminal current data.

2. The method of claim 1, wherein extracting additional DC parameters further comprises:
extracting voltage related parameters;
using the extracted voltage related parameters to extract length related parameters, and first and second resistance related parameters;
additionally using said extracted first and second resistance related parameters to extract mobility related parameters and width related parameters;
additionally using said extracted mobility and width related parameters to extract sub-threshold region related parameters;
using the extracted voltage related parameters to extract drain induced barrier lower related parameters; and
using the extracted voltage related parameters, length related parameters, first and second resistance related parameters, mobility related parameters, width related parameters, sub-threshold region related parameters, and drain induced barrier lower related parameters to extract drain saturation current related parameters.

3. A method for extracting semiconductor device model parameters comprising:
obtaining terminal current data corresponding to various bias conditions in a set of test devices;
extracting I_{diode} related parameters and I_{bjt} related parameters from the terminal current data;
modifying the terminal current data using the extracted I_{diode} related parameters and I_{bjt} related parameters; and
extracting additional DC parameters from the modified terminal current data.

4. The method of claim 4, wherein extracting additional DC parameters further comprises:
extracting Vₜₕ related parameters;
using the extracted Vₜₕ related parameters to extract L_{eff} related parameters, R_{d} related parameters and Rₛ related parameters;
using the extracted Vₜₕ related parameters, L_{eff} related parameters, R_{d} related parameters and Rₛ related parameters to extract mobility related parameters and W_{eff} related parameters;
using the extracted Vₜₕ related parameters, L_{eff} related parameters, R_{d} related parameters, Rₛ related parameters, mobility related parameters and W_{eff} related parameters to extract sub-threshold region related parameters;
using the extracted Vₜₕ related parameters to extract drain induced barrier lower related parameters; and
using the extracted Vₜₕ related parameters, L_{eff} related parameters, R_{d} related parameters, Rₛ related parameters, mobility related parameters and W_{eff} related parameters, sub-threshold region related parameters, and drain induced barrier lower related parameters to extract I_{dsat} related parameters.

5. The method of claim 3, wherein extracting additional DC parameters further comprises:
extracting junction related parameters.

6. The method of claim 3, wherein the terminal current data comprises I_{d} v. V_{gs} curves, and wherein extracting I_{diode} related parameters further comprises:
extracting J_{sbjt} and n_{dio} using a middle part of at least one I_{d} v. V_{gs} curve measured in a largest device among the set of test devices;
extracting R_{body} using high current parts of I_{d} v. V_{gs} curves measured in test devices having different sizes; and
extracting n_{recf} and j_{srec} using one or more I_{d} v. V_{gs} curves measured in a shortest device among the set of test devices.

7. The method of claim 3, wherein extracting I_{bjt} related parameters further comprises:
constructing from the terminal current data a set of I_{c}/Iₚ v. V_{gs} curves for a shortest device; and
extracting Lₙ using the set of I_{c}/Iₚ v. V_{gs} curves.

8. The method of claim 3, wherein extracting additional DC parameters comprises:
extracting Iᵢᵢ related parameters;

9. The method of claim 8, wherein the terminal current data comprises Iₚ v. V_{gs} curves and I_{d} v. V_{gs} curves, and wherein extracting Iᵢᵢ related parameters further comprises:
constructing a set of Iᵢᵢ/I_{d} V. V_{gs} curves from Iₚ v. V_{gs} curves and I_{d} v. V_{gs} curves measured in a shortest device and modified using the extracted I_{diode} related parameters and I_{bjt} related parameters;
extracting α₀, β₀, β₁, and β₂ using the constructed Iᵢᵢ/I_{d} v. V_{gs} curves;
extracting V_{dsatii} by averaging over an array of V_{dsatii} values, the array of V_{dsatii} values being obtained by finding a point in each Iᵢᵢ/I_{d} v. V_{gs} curve where Iₚ/I_{d}=α₀; and
extracting Lᵢᵢ using the array of V_{dsatii} values.

10. The method of claim 9, further comprising:
optimizing the extracted α₀, β₀, β₁, β₂, V_{dsatii}, and Lᵢᵢ parameters

11. A method for extracting semiconductor device model parameters comprising:
obtaining terminal current data corresponding to various bias conditions in a set of test devices;
extracting I_{dgid1} related parameters, I_{sdig1} related parameters, and I_{g} related parameters from the terminal current data;
modifying the terminal current data using the extracted I_{dgid1} related parameters, I_{sdig1} related parameters, and I_{g} related parameters; and
extracting additional DC parameters from the modified terminal current data.

12. The method of claim 11, wherein obtaining terminal current data further comprises:
obtaining measured terminal current data corresponding to various bias conditions in a set of test devices;
extracting I_{diode} related parameters and I_{bjt} related parameters from the terminal current data; and
modifying the measured terminal current data using the extracted I_{diode} related parameters and I_{bjt} related parameters.

13. The method of claim 11, wherein extracting additional DC parameters further comprises:
extract L_{eff} related parameters, R_{d} related parameters and Rₛ related parameters;
using the extracted L_{eff} related parameters, R_{d} related parameters and Rₛ related parameters to extract mobility related parameters and W_{eff} related parameters;
using the extracted L_{eff} related parameters, R_{d} related parameters, Rₛ related parameters, mobility related parameters and W_{eff} related parameters to extract sub-threshold region related parameters; and
using the extracted L_{eff} related parameters, R_{d} related parameters, Rₛ related parameters, mobility related parameters, W_{eff} related parameters, and sub-threshold region related parameters to extract I_{dsat} related parameters

14. The method of claim 11, wherein extracting additional DC parameters comprises:
extracting junction related parameters.

15. A method of extracting I_{diode} related parameters for modeling a SOI MOSFET device, comprising:
obtaining terminal current data corresponding to various bias conditions in a set of test devices, the terminal current data including I_{d} v. Vₚₛ curves;
extracting J_{sbjt} and n_{dio} using a middle part of at lease one I_{d} v. Vₚₛ curve measured in a largest device among the set of test devices;
extracting R_{body} using high current parts of the I_{d} v. Vₚₛ curves measured in test devices having different sizes; and
extracting n_{recf} and j_{srec} using I_{d} v. Vₚₛ curves measured in a shortest device among the set of test devices.

16. A method of extracting I_{bjt} related parameters for modeling a SOI MOSFET device, comprising:
obtaining terminal current data corresponding to various bias conditions in a set of test devices, the terminal current data including I_{d} v. Vₚₛ curves;
constructing from the terminal current data a set of I_{c}/Iₚ v. Vₚₛ curves for a shortest device; and
extracting Lₙ using the set of I_{c}/Iₚ v. Vₚₛ curves.

17. A method of extracting Iᵢᵢ related parameters for modeling a SOI MOSFET device, comprising:
obtaining terminal current data corresponding to various bias conditions in a set of test devices, the terminal current data including Iₚ v. V_{gs} curves and I_{d} v. V_{gs} curves;
constructing a set of Iᵢᵢ/I_{d} v. V_{gs} curves from Iₚ v. V_{gs} curves and I_{d} v. V_{gs} curves measured in a shortest device;
extracting α₀, β₀, β₁, and β₂ using the constructed Iᵢᵢ/I_{d} v. V_{gs} curves;
extracting V_{dsatii} by averaging over an array of V_{dsatii} values, the array of V_{dsatii} values being obtained by finding a point in each Iᵢᵢ/I_{d} v. V_{gs} curve where Iₚ/I_{d}=α₀; and
extracting Lᵢᵢ using the array of V_{dsatii} values.

18. A computer program product for use in conjunction with a computer system, the computer program product comprising a computer readable storage medium and a computer program mechanism embedded therein, the computer program mechanism comprising:
logic for obtaining terminal current data corresponding to various bias conditions in a set of test devices;
logic for extracting first and second current related parameters from the terminal current data;
logic for modifying the terminal current data using said extracted first current related parameters and second current related parameters; and
logic for extracting additional DC parameters from the modified terminal current data.

19. The computer program product of claim 18, wherein the logic for extracting additional DC parameters further comprises:
logic for extracting voltage related parameters;
logic for using the extracted voltage related parameters to extract length related parameters, and first and second resistance related parameters;
logic for additionally using said extracted first and second resistance related parameters to extract mobility related parameters and width related parameters;
logic for additionally using said extracted mobility and width related parameters to extract sub-threshold region related parameters;
logic for using the extracted voltage related parameters to extract drain induced barrier lower related parameters; and
logic for using the extracted voltage related parameters, length related parameters, first and second resistance related parameters, mobility related parameters, width related parameters, sub-threshold region related parameters, and drain induced barrier lower related parameters to extract drain saturation current related parameters.

20. A system for extracting semiconductor device model parameters, comprising:
a central processing unit (CPU);
a port or I/O device communicating with the central processing unit to provide terminal current data to the CPU corresponding to various bias conditions in a set of test devices;
a memory communicating with the CPU and containing instructions executable by the CPU to extract I_{diode} related parameters and I_{bjt} related parameters from said terminal current data, to modify said terminal current data based on the extracted I_{diode} and I_{bjt} related parameters and to extract additional DC parameters based on said modified terminal current data.

21. The system according to claim 20, wherein said memory further contains instructions executable by the CPU to:
extract Vₜₕ related parameters;
use the extracted Vₜₕ related parameters to extract L_{eff} related parameters, R_{d} related parameters and Rₛ related parameters;
use the extracted Vₜₕ related parameters, L_{eff} related parameters, R_{d} related parameters and Rₛ related parameters to extract mobility related parameters and W_{eff} related parameters;
use the extracted Vₜₕ related parameters, L_{eff} related parameters, R_{d} related parameters, Rₛ related parameters, mobility related parameters and W_{eff} related parameters to extract sub-threshold region related parameters;
use the extracted Vₜₕ related parameters to extract drain induced barrier lower related parameters; and
use the extracted Vₜₕ related parameters, L_{eff} related parameters, R_{d} related parameters, Rₛ related parameters, mobility related parameters, W_{eff} related parameters, sub-threshold region related parameters, and drain induced barrier lower related parameters to extract I_{dsat} related parameters.

22. The system of claim 20, wherein the terminal current data comprises I_{d} v. Vₚₛ curves, and wherein the instructions for extracting I_{diode} related parameters comprise instructions to:
extract J_{sbjt} and n_{dio} using a middle part of I_{d} v. Vₚₛ curves measured in a largest device among the set of test devices;
extract R_{body} using a high current part of the I_{d} v. Vₚₛ curves measured in test devices having different sizes; and
extract n_{recf} and j_{srec} using I_{d} v. Vₚₛ curves measured in a shortest device among the set of test devices.

23. The system of claim 20, wherein the instructions for extracting I_{bjt} related parameters comprise instructions to:
construct from the terminal current data a set of I_{c}/Iₚ v. Vₚₛ curves for a shortest device; and
extract Lₙ using the set of I_{c}/Iₚ v. Vₚₛ curves.

24. The system of claim 20, wherein the terminal current data comprises Iₚ v. V_{gs} curves and I_{d} v. V_{gs} curves, and wherein the instructions for extracting additional DC parameters include instructions for extracting Iᵢᵢ related parameters, and the instructions for extracting Iᵢᵢ related parameters comprises instructions to:
construct a set of Iᵢᵢ/I_{d} v. V_{gs} curves from Iₚ v. V_{gs} curves and I_{d} v. V_{gs} curves measured in a shortest device and modified using the extracted I_{diode} related parameters and I_{bjt} related parameters;
extract α₀, β₀, β₁, and β₂ using the constructed Iᵢᵢ/I_{d} v. V_{gs} curves;
extract V_{dsatii} by averaging over an array of V_{dsatii} values, the array of V_{dsatii} values being obtained by finding a point in each Iᵢᵢ/I_{d} v. V_{gs} curve where Iₚ/I_{d}=α₀; and
extract Lᵢᵢ using the array of V_{dsatii} values.
